(19) United States
(12) Patent Application Publication
(10) Pub. No.: US 2012/0031430 A1
(43) Pub. Date: Feb. 9, 2012

(54) CLEANING DEVICE AND A CLEANING METHOD

(75) Inventor: Trygve Thykjær, Holte (DK)

(73) Assignee: SMARTWATCH INVEST APS, Hole, DK (unknown)

(21) Appl. No.: 13/255,547

(22) PCT Filed: Dec. 28, 2009
(86) PCT No.: PCT/DK09/50356

§ 371 Date: Oct. 12, 2011

(30) Foreign Application Priority Data
Mar. 11, 2009 (DK) PA200900337

(51) Int. Cl. B08B 9/00

(52) U.S. Cl. 134/6; 15/104.05

(57) ABSTRACT

Disclosed is a method and a device for cleaning a container such as a toilet bowl. The device includes an expandable member which is operable to seal an opening, such as a drain opening, in the container so as to allow a cleaning agent to be retained in the container.

The present invention relates to a cleaning device which can be used for cleaning of toilets.

### BACKGROUND OF INVENTION

Standard toilets need to be cleaned frequently in order to remove calcium deposits on the toilet bowl and other contaminants. In particular, the frequency of cleaning may depend on the amount of calcium or the like of the local water. It is known that cleaning of a toilet bowl can be carried out by spraying a liquid cleaning agent, such as a detergent, onto the substances, such as calcium deposits, which have accumulated on the toilet bowl, whereafter mechanical cleaning is provided, for instance by applying a cleaning brush. However, such a cleaning process has several disadvantages. For instance, the cleaning agent is usually is not very effective in removing the unwanted substances due to the adhesion problems in relation to steep and smooth surfaces of the toilet bowl which affect the impact time of the cleaning agent. In addition, detergents are diluted in the water of the toilet and thereby reduced in efficiency. In a related procedure a cleaning agent is forced to stick to the areas having calcareous sediments by using a cleaning agent together with a sticking means, such as a piece of cloth, but such a solution has problems in that the cleaning agent disadvantageously can be contained in the sticking means rather than forced towards the calcareous sediments.

In addition, toilet bowls have surfaces which are not easily accessible when the above-described cleaning process is used, such surfaces include the rim portion and the drain portion of the toilet bowl. In order to clean calcareous sediments and other contaminants, a solution may therefore advantageously involve an expandable member which is used close the drain of the toilet whereafter the toilet can be filled with a cleaning agent. Solutions employing such an expandable member are disclosed in the references beneath.

In U.S. Pat. No. 2,311,197 is disclosed a cleaning process for removal of extraneous matter from the interior of a urinal metal trap. The cleaning process is carried out by use of an expansible collapsing plug and air-pump whereby the plug is expanded until properly placed in the metal trap.

Another solution is disclosed in DE 100 32 439 C1, wherein a cleaning method is disclosed which involves sealing of an outlet of a toilet bowl by an inflatable balloon whereafter the toilet bowl is filled with water and a cleaning tablet is inserted therein. The water is discharged by re-opening outlet after the cleaning tablet has performed its function in predetermined cleaning interval.

Further, another apparatus for closing a trap is disclosed in U.S. Pat. No. 300,636, wherein there is disclosed an apparatus comprising a hollow air-tight collapsible ball attached to the end of a rubber pipe, and said apparatus being adapted to be inserted in the outlet of a trap whereby the trap can be closed by inflating the ball with an air-pump.

However, the solutions described in the above-mentioned documents are subject to difficulties in relation to controlling the position of the inflatable element.

### SUMMARY OF INVENTION

To overcome the mentioned difficulties, it is an object of the invention to provide a cleaning device and a cleaning method with an improved means in relation to the position of an expandable member.

The object is achieved by a cleaning device comprising an expandable member, a means for expanding the expandable member, and a connection means for connecting the expandable member and the means for expanding the expandable member characterized in that the connection means comprises a measuring means. In a preferred embodiment of the cleaning device, the expandable member has a droplet shape or an elliptical shape and is made of latex. Preferably, the connection means comprises a first tube member. The expandable member may thereby easily be inflated for instance by use of air.

In a preferred embodiment of the cleaning device, the measuring means comprises a length measuring means. The measuring means can thus be a position means for positioning the expandable member. In a related embodiment, the measuring means comprises a length measuring means, such as a length indicator scale having at least one length indicator. The length measuring means may preferably comprise a second tube member extending from the expandable member and said second tube member being adapted for engagement with the first tube member. The second tube member may be shorter than the first tube member, and said second tube member may encapsulate a portion of the first tube member. Further, the second tube member may have an end portion being provided at a predetermined lengthwise position on a portion of the first tube member. The predetermined lengthwise position can be used to place the expandable member in a correct position when used in a cleaning process. The predetermined lengthwise position is useful for instance when the cleaning device is used with a toilet. The expandable member is thus adapted for precise arrangement in the trap of a toilet, such as a water lock of a toilet, which often is an S-shaped bend.

In one embodiment of the cleaning device, the expandable member comprises a reinforced portion. By such a reinforced portion, an advantage is gained in that the portion of the connection means close to the expandable member and the portion of the expandable member close to the connection means are prevented from or reduce developing of sharp bends that may act as a barrier when the expandable member is expanded or contracted. Further, in another embodiment, the cleaning device comprises a valve means, such as a three-port valve, for contracting the expandable member. Such a valve means is advantageous in contracting the expandable member by pressure release.

In another aspect of the invention, there is provided a method for cleaning a container having at least a first opening using a cleaning device according to any of the preceding claims, said method comprising the steps of arranging the expandable member of the cleaning device in the first opening, such as an S-bend of a toilet, by using the measuring means; expanding the expandable member in order to seal the first opening; applying a cleaning process to the container; contracting the expandable member, and removing the expandable member from the first opening. The container is preferably a toilet bowl but can be any container having an opening which is adapted to be closed by an expandable member.

In one embodiment, the cleaning process comprises a step wherein the container is filled with a cleaning agent which may comprise cleaning tablets or a solution of acetic acid. Cleaning of a toilet is thereby easily accomplished. The time needed by the operator is short since the operator only needs to position the expandable member in the toilet drain and filling the toilet bowl with the cleaning agent, an operation which may take less than 5 min. for the experienced user. Afterwards, the cleaning agent is doing the work for the operator in a period which is defined by the operator and which may depend on the cleanliness of the toilet bowl.

### BRIEF DESCRIPTION OF THE DRAWINGS

The invention is disclosed in more detail with reference to the accompanying drawings, in which:

FIG. 1 is a side view of the cleaning device according to a preferred embodiment of the invention,

FIG. 2 is a cross section view of the cleaning device arranged in a toilet, and

FIG. 3 is another side view of the cleaning device in FIG. 1.

### DETAILED DESCRIPTION OF THE DRAWINGS

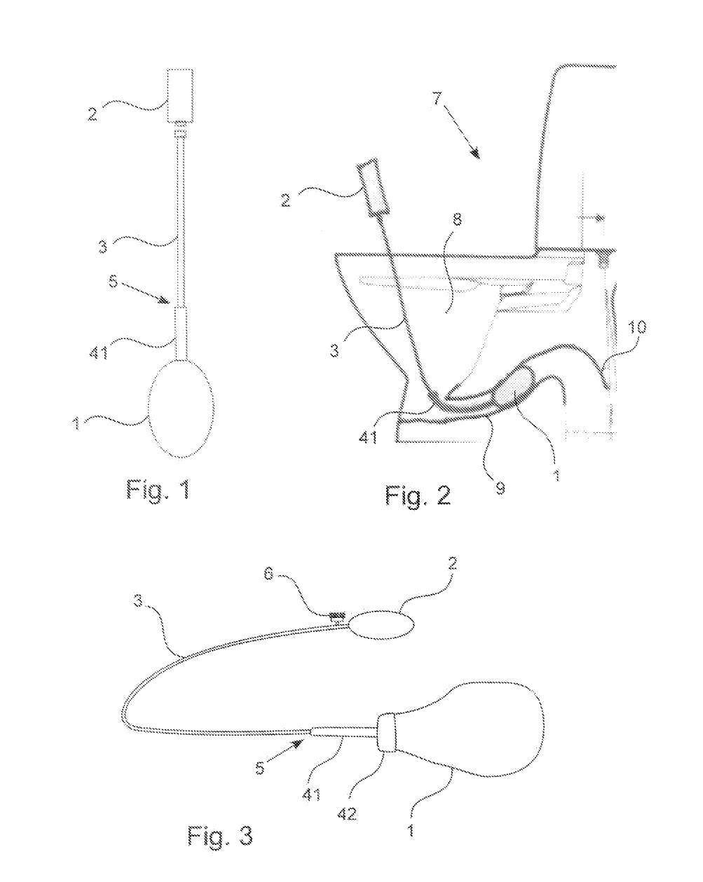

With reference to FIG. 1 and FIG. 3, the cleaning device is shown having an inflatable balloon 1, which has a diameter of 11 cm measured when it is deflated and thus having a flat round shape, connected to a hand pump 2 by a first tube 3 extending from the hand pump 2 and a second tube 41 extending from a reinforced portion 42 of the inflatable balloon 1 so that the end portion of the second tube 41 defines a predetermined position 5 distanced approximately 7 cm from the inflatable balloon 1 and 65 cm from the hand pump 2. Further, the cleaning device may have a three-way valve 6 for pressure release. Preferably, the reinforced portion 42 has a portion with a cylindrical shape, which in one embodiment has a height of 2.5 cm and a diameter of 4 cm. Further, the reinforced portion 42 has a portion made of a material that is more rigid than the material of the second tube 41 and/or the material of the inflatable balloon 1. In particular, the reinforced portion 42 may comprise a rigid circular member. By such a reinforced portion 42, an advantage is gained in that the tube portion close to the inflatable balloon and the portion of the inflatable balloon 1 close to the tube are prevented from developing sharp bends that may act as a barrier when air is transmitted to and from the balloon 1. In one embodiment, the second tube 41 and the reinforced portion 42 are provided as a one-piece member.

With reference to FIG. 3, the cleaning device with the inflated balloon 1 is arranged in a toilet 7 having a toilet bowl 8 and a trap, i.e. an S-shaped bend, said S-shaped bend having a first narrow portion 9 close to the toilet bowl 8 and a second wider portion 10 close to the drain. When the inflatable balloon is arranged in the S-bend, it is important that the balloon 1 is not positioned too far from the toilet bowl, i.e. preferably not at the second portion 10 of the S-shaped bend because the balloon 1 preferably is dimensioned to expand in the first narrow portion 9 of the S-shaped bend. In order to position the balloon in the right place, the operator of the cleaning device makes sure that the predetermined position 5, defined by the end portion of the second tube, is visible just outside the opening of the bend when the balloon is inflated. In this embodiment, the end of the second tube is thereby the position measurement indicator. By the invention, it is realised that the measurement means may be provided integrally in the device as described above or a separate member mounted onto the inflation tube or the like of the device.

### CLEANING EXAMPLE

The operator may choose if the water standing in the toilet has to be removed or not, to remove the water, the operator may use a toilet brush to push the water past the S-bend of the toilet. The deflated balloon is positioned in the toilet trap in such a way that the reinforced part of the tube extending from the balloon is just visible. The balloon is now inflated by use of the hand pump, which has to be pushed approximately 50 times, until it shuts the toilet drain. The pump should not be pushed more than 60 times otherwise the balloon may burst. If acetic acid is used for cleaning, the following steps are carried out. 1 liter of acetic acid is poured into the toilet bowl followed by water from the tap with a temperature of approximately 40-50° C. until the toilet bowl is filled up with water. The resulting acetic acid solution is left to work on the calcareous sediments for minimum 30 min. Next, the water is emptied from the toilet bowl by deflating the balloon which is carried out by opening the pressure release valve. The operator needs to retain the balloon from getting flushed out by applying a firm grip on the reinforced part of the tube extending from the balloon. When the water has been flushed out the balloon is removed by pulling the reinforced part of the tube extending from the balloon. The toilet bowl can optionally be scoured by a sponge with a cleaning agent. If tablets are used, the following steps are performed. The toilet bowl is filled with water having a temperature of approximately 40° C. whereafter the tablets (preferably 8 tablets) are added. The solution is left alone for 6 hours, for instance over night. Next, the water is emptied from the toilet bowl in the same way as described above for the case of acetic acid as a cleaning agent. It is of course realised that other types of cleaning agents may be used and that the cleaning method using the device may also be performed using cleaning agents at room temperature.

While specific and preferred embodiments of the invention have been shown and described in detail above to illustrate the inventive principles, it is realised that variants to these embodiments may be provided without departing from the scope of the invention as set forth in the accompanying claims. For instance, the expandable member is not limited for use with toilets but can be used with any container having an opening which is adapted to be closed by an expandable member.

1. A cleaning device comprising
an expandable member,
a means for expanding the expandable member,
and a connection means for connecting the expandable member and the means for expanding the expandable member, wherein the connection means comprises a measuring means.

2. The cleaning device according to claim 1, wherein the connection means comprises a first tube member.

3. The cleaning device of claim 1, wherein the expandable member has an elliptical shape.

4. The cleaning device of claim 1, wherein the expandable member is made of latex.

5. The cleaning device of claim 1, wherein the measuring means comprises a length measuring means.

6. The cleaning device according to claim 5, wherein the length measuring means comprises a second tube member extending from the expandable member wherein the second tube member is engageable with the first tube member.

7. The cleaning device according to claim 6, wherein the second tube member is shorter than the first tube member, and said second tube member encapsulates a portion of the first tube member.

8. The cleaning device according to claim 6, wherein the second tube member has an end portion, said end portion being provided at a predetermined lengthwise position on a portion of the first tube member.

9. The cleaning device of claim 1, wherein the expandable member comprises a reinforced portion.

10. The cleaning device of claim 1, comprising a valve means, such as a three -port valve, for contracting the expandable member.

11. A method for cleaning a container having at least a first opening using the cleaning device of claim 1, said method comprising the steps of
arranging the expandable member of the cleaning device in the first opening of the container by using the measuring means;
expanding the expandable member in order to seal the first opening;
applying a cleaning process to the container;
contracting the expandable member, and
removing the expandable member from the first opening.

12. The method according to claim 11, wherein the container is a toilet bowl.

13. The method according to claim 11, wherein the cleaning process comprises a step wherein the container is filled with a cleaning agent.
